(19) United States
(12) Patent Application Publication
(10) Pub. No.: US 2003/0105715 A1
(43) Pub. Date: Jun. 5, 2003

(54) System and method for increasing security of electronic monetary transactions

(76) Inventors: Gabriel Friedman, Givataim (IL); Uri Levy-Itzchak, Givataim (IL); Yitzhak Shachar, Kfar Azar (IL)

Correspondence Address: Anthony Castorina, GE Ehrlich, Suite 207, 2001 Jefferson Davis Highway, Arlington, VA, 22202, US

(21) Appl. No.: 10/069,012

(22) PCT Filed: Mar. 8, 2001
(86) PCT No.: PCT/IL01/00219

(30) Foreign Application Priority Data
Mar. 20, 2000 (US) 09/531,484

(51) Int. Cl. G06F 17/60

(52) U.S. Cl. 705/43

(57) ABSTRACT

A system and method of facilitating electronic monetary transactions. The system having an automatic teller machine (20) and a server (14). The automatic machine (20) being constructed for debiting an account of a user (40) and/or accepting the credit code, and updating the server with the credit code and the amount of currency associated, thereby establishing a virtual user account, the server (14) is designed for receiving data and currency amount from the credit code from the automatic teller machine (20), receiving or issuing an identification code and associating the identification code with the credit code, thereby activating the virtual user account, and debiting the virtual user account by a specified currency sum upon request when presented with the credit code, identification code, and the specified sum.

### FIELD AND BACKGROUND OF THE INVENTION

The present invention relates to a system and method for conducting electronic monetary transactions and, more particularly, to a system and method which reduce the risk of fraud and theft, and which further protect consumer privacy, during purchases conducted electronically.

It is well known that the Internet represents the fastest growing media and encompasses, inter-entities communication, source of on-line data, electronic commerce (e-commerce) and sales promotion. The market for Internet services was valued at $11.3 billion in 1997, and is expected to reach over $39 billion by year 2002. As a result, the Internet is developing as a global marketplace, with evolving infrastructures for e-commerce. Companies engaging in e-commerce via the Internet promote sales of products (i.e., goods or services) through the network. Payment is generally rendered by use of a user specific card (e.g., credit card, debit card), corresponding to a user account which, in turn corresponds to a set of user information (e.g. address, telephone number, e-mail address, etc.). Generally the user is required to forward such information to the seller.

Because of the tremendous growth in e-commerce, there is a potential for theft and fraud and a number of server security systems have been developed to minimize this risk. In addition, the idea that one or more unknown parties may acquire personal information regarding their identity, tastes and habits deters many potential consumers from engaging in e-commerce. These same considerations apply to credit card/debit card transactions via conventional means such as telephone purchases and mail order purchases.

In addition, some consumers do not have a credit card or a debit card, relying instead upon cash.

For these reasons, “electronic cash” has been offered as a purchase option (see, http://www.spendcash.com). Electronic cash is actually a prepaid temporary account from which an accountholder may draw against until the balance is depleted. While the card is user specific by virtue of a personal identification number (PS) chosen by the purchaser, use of the card does not allow access to any information about the user other than that associated with the card. Since the card has a lifetime limited by the initial balance in the card account, collection of information regarding user tastes and habits is less feasible, and correlating between such information and user identity is nearly impossible. In addition, the use's exposure to theft or fraud is limited to the account balance. Electronic cash, in its current configuration, requires purchase and subsequent activation via an Internet server with an activation Web page. Typically, this activation must be conducted by the user from a user client The user client is most often not available to the user at the point of purchase of the electronic cash, typically in a retail outlet (point of sale). This activation step is inconvenient and may deter some potential consumers from using electronic cash in its current configuration. In addition, because the electronic cash system is currently separate from central banking clearinghouses used by credit card and debit card companies, electronic cash currently enjoys limited acceptance. Further, this electronic cash is currently only redeemable at Internet vendors. Still further, electronic cash is distributed in predefined values and its physical distribution may lead to its unavailability in terms of time of distribution and stock depletion.

There is thus a widely recognized need for, and it would be highly advantageous to have, a system and method for conducting electronic monetary transactions which reduce the risk of fraud and theft, and which further protect consumer privacy, during purchases conducted electronically devoid of the above limitation.

### SUMMARY OF THE INVENTION

According to one aspect of the present invention there is provided a system of facilitating electronic monetary transactions. The system comprises an automatic teller or point of sell machine and a server. The automatic teller or point of sell machine is constructed and designed for (i) debiting an account of a user and/or accepting from the user an amount of currency; (ii) issuing or receiving from a server a credit code being associated with the amount of currency and informing the user of the credit code; and (iii) updating the server with the amount of currency and if required with the credit code being associated therewith, thereby establishing a virtual user account. The server is capable of communication with the automatic teller or point of sell machine and is constructed and designed for (i) receiving data from the automatic teller or point of sell machine of the credit code and the amount of currency being associated therewith; (ii) receiving or issuing an identification code and associating the identification code with the credit code, thereby activating the virtual user account; and (iii) debiting the virtual user account by a specified sum of currency upon request when presented with the credit code, identification code and the specified sum.

According to another aspect of the present invention there is provided a method of facilitating electronic monetary transactions. The method comprises the steps of providing an automatic teller or point of sell machine and a server. The automatic teller or point of sell machine is for (i) debiting an account of a user and/or accepting from the user an amount of currency; (ii) issuing or receiving from a server a credit code being associated with the amount of currency and informing the user of the credit code, (ii) updating the server with the amount of currency and if required with the credit code being associated therewith, thereby establishing a virtual user account The server is capable of communication with the automatic teller or point of sell machine and is for (i) receiving from the automatic teller or point of sell machine the credit code and the amount of currency being associated therewith; (ii) receiving or issuing a personalized identification code and associating the identification code with the credit code, thereby activating the virtual user account; and (iii) debiting the virtual user account by a specified sum of currency upon request when presented with the credit code, identification code and the specified sum.

According to further features in preferred embodiments of the invention described below, the account of the user is selected from the group consisting of a bank account, a debit card account and a credit card account, whereas the automatic teller or point of sell machine is further constructed and designed for communicating with a server of a bank and/or a credit or debit provider.

According to still further features in the described preferred embodiments, the specified sum of currency, credit code and identification code are presented to the server by the user via a user client at a discretion of the user.

According to still further features in the described preferred embodiments, the specified sum of currency, credit code and identification code are presented to the server by a vendor with the agreement of the user.

According to still further features in the described preferred embodiments, the identification code and the credit code are each independently a string of alphanumeric characters.

According to still further features in the described preferred embodiments, the credit code is issued in a form selected from the group consisting of a string of alphanumeric characters displayed upon a visual display, a string of alphanumeric characters delivered audibly from a speaker and a string of alphanumeric characters printed upon a tangible media.

According to still further features in the described preferred embodiments, the identification code associated with the credit code is generated by a means selected from the group consisting of (i) a user choice of the identification code communicated to the server by means of an input device of the automatic teller or point of sell machine; (ii) a user choice of the identification code communicated to the server by means of an input device of a user client at a discretion of the user; (iii) an assignment by the automatic teller or point of sell machine of the identification code, once assigned the identification code being subsequently communicated to the server and provided to the user and (iv) an assignment by the server of the identification code, once assigned the identification code being subsequently provided to the user.

According to still further features in the described preferred embodiments, the automatic teller or point of sell machine includes at least one item selected from the group consisting of (i) a monitor for visual display of data; (ii) a printer for printing data on a tangible media; (iii) a data input device; (iv) a mechanism for accepting, identifying and counting currency of at least one types; (v) at least one audio speaker for delivery of audio data; (vi) at least one mechanism for reading information encoded on a magnetic stripe; (vii) a bar code reader, (viii) a dispenser of pre-printed items.

The present invention successfully addresses the shortcomings of the presently known configurations by providing a system and method for conducting electronic monetary transactions which reduce the risk of fraud and theft, and which further protect consumer privacy, during purchases conducted electronically which allows concurrent establishment and activation of a virtual user account, which may be used to conduct a wide variety of transactions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagram of an automatic teller or point of sell machine according to the present invention in communication with a server according to the present invention; and

FIG. 2 is a diagram of a system for facilitating electronic monetary transactions according to the present invention.

### DESCRIPTION OF THE PREFERRED EMBODIMENTS

The present invention is of a system and method for conducting electronic monetary transactions which can be used to reduce the risk of fraud and theft, and which can further be used to protect consumer privacy, during purchases conducted electronically. Specifically, the present invention can be used to effect monetary transactions by means of a temporary user account which is identified solely by a credit code and an identification code.

The principles and operation of a system and method for conducting electronic monetary transactions according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase “user client” generally refers to a computer and includes, but is not limited to, personal computers (PC) having an operating system such as DOS, Windows™, OS/2™ or Linux; Macintosh™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having computer/Internet capabilities and Web TVs.

For purposes of this specification and the accompanying claims, the term “Windows™” includes but is not limited to Windows2000™, Windows95™, Windows 3.x™ in which “x” is an integer such as “1”, Windows NT™, Windows 98™, Windows CE™ and any upgraded versions of these operating systems by Microsoft Corp. (USA).

For purposes of this specification and the accompanying claims, the phrase “Web browser” refers to any software program which can display text graphics, or both, from Web pages on World Wide Web sites and/or local files.

For purposes of this specification and the accompanying claims, the phrase “Web page” refers to any document written in a “mark-up language”. For purposes of this specification and the accompanying claims, the phrase “mark up language” includes, but is not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator).

For purposes of this specification and the accompanying claims, the term “Web site” refers to at least one Web page, and preferably a plurality of Web pages, virtually connected to form a coherent group.

For purposes of this specification and the accompanying claims, the term “Web server” refers to a server for providing one or more Web pages to a Web browser upon request.

For purposes of this specification and the accompanying claims, the phrase “display a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

For purposes of this specification and the accompanying claims, the phrase “automatic teller machine” refers to a device capable of allowing self operated banking actions. Both automatic teller machines located in a branch of a bank and those located at other locations are specifically included in this definition. Examples of transactions conductible by a user at an automatic teller machine specifically include, but are not limited to, debit of an account or credit to an account or deposit of cash to an account. Therefore, automatic teller machines with one or more capabilities including, but not limited to, reading coded information on a card (such as an automatic teller machine card) or identifying and counting currencies, either bills or coins, are specifically included.

For purposes of this specification and the accompanying claims, the phrase “automatic point of sell machine” refers to a device capable of allowing commerce actions and which are located at a point of sell. Examples of transactions conductible at an automatic point of sell machine specifically include, but are not limited to, debit of an account or credit to an account or deposit of cash. Therefore, automatic point of sell machines with one or more capabilities including, but not limited to, reading coded information on a card (such as an automatic point of sell machine card), printing and/or presenting data are available.

As used herein the term “automatic” embraces both complete and partial or semi automation.

As used herein the term “machine” refers to a single device or a plurality of devices operating in concert.

For purposes of this specification and the accompanying claims, the phrase “automatic teller machine card” or “automatic point of sell machine card” both refer to a card readable by an automatic teller or point of sell machine including, but not limited to a credit card and a debit card. Specifically included in this definition are Visa™ cards, MasterCard™, American express™ cards, Diners Club™ cards, JCB™ cards and/or cards belonging to networks such as PLUS™, CIRRUS™, PULSE™ or MAC™. Also included are credit/debit cards issued by retailers and which are limited for conducting transactions with these retailers.

For purposes of this specification and the accompanying claims, the term “communication” refers to any means of data transfer including, but not limited to, data transfer by a telephone connection, a cellular telephone connection, an Internet connection, an infrared frequency transmission connection, a local area network connection and a radio frequency connection.

For purposes of this specification and the accompanying claims, the terms “monitor” and “display” are used interchangeably to refer to a device which visually presents data to a user. Specifically included in the definition are cathode ray tube display screens, liquid crystal displays and light emitting diodes.

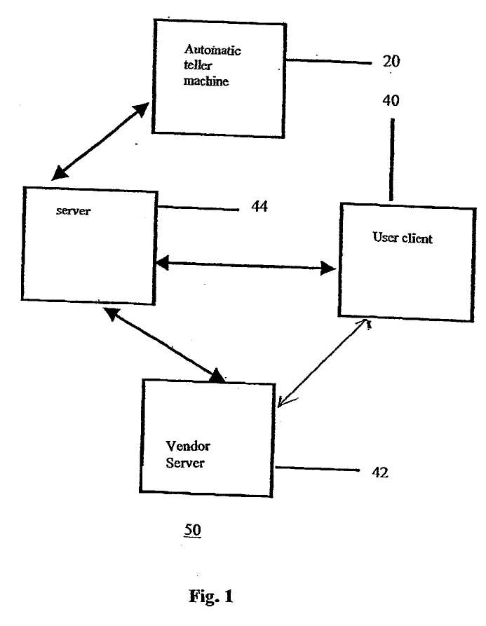

FIG. 1 schematically shows a system for facilitating electronic monetary transactions according to the present invention, which is referred to hereinbelow as system 50.

System 50 includes at least one automatic teller or point of sell machine 20 (only one is pictured) and a server 44 which are capable of bi-directional data communication therebetween.

Automatic teller or point of sell machine 20 is constructed and designed to perform at least three functions relevant to the present invention.

The first function is debiting an account of a user and/or accepting from the user an amount of currency. The account of the user may, for example, be a bank account, a debit card account or a credit card account. It can also be a virtual user account of the user, as this term is further described hereinunder, or of another user to which the user have authorized access. In this case, automatic teller or point of sell machine 20 is further constructed and designed for communicating with a server of a bank or credit or debit provider.

The second function of automatic teller or point of sell machine 20 includes issuing or receiving from server 44 a credit code which is subsequently associated with the amount of currency and informing the user of the credit code.

The third function of automatic teller or point of sell machine 20 includes updating server 44 with the amount of currency and, if required, with the credit code which is associated therewith, thereby establishing a virtual user account at server 44.

Server 44 can be a Web server and is capable of communication with automatic teller or point of sell machine 20 and is also constructed and designed to perform at least three functions relevant to the present invention.

The first function of server 44 includes receiving data from automatic teller or point of sell machine 20 pertaining to the credit code and the amount of currency associated therewith.

The second function of server 44 includes receiving or issuing an identification code and associating the identification code with the credit code, thereby activating the virtual user account.

For purposes of this specification and the accompanying claims, the phrase “virtual user account” includes temporary accounts which are automatically closed when the balance thereof reaches zero. Since virtual user accounts may often remain with small balances which are of little practical use, the scope of the present invention specifically includes the possibility of allowing a user to combine two or more virtual user accounts into a single virtual user account, to cash the balance, deposit the balance to another account such as a virtual account and/or a bank, credit or debit account of the user and/or other user(s). These functions can, according to preferred embodiments of the present invention, be executed either by a user client at the user's discretion and/or the automatic teller or point of sell machine.

The third function of server 44 includes debiting the virtual user account by a specified sum of currency upon request when presented with the credit code, identification code and the specified sum. This third function of server 44 is repeatable upon user request until the balance in the virtual user account reaches zero. In some cases, this will occur when the balance in the virtual user account is transferred to a second virtual user account, as described hereinabove.

Presentation of the specified sum of currency, credit code and identification code for performance of this third server function may, according to preferred embodiments of the present invention, occur in at least two ways. The first way is for the user to present the specified sum of currency, credit code and identification code to server 44 via a user client 40 which is at the discretion of the user. The second way is for an vendor to present specified sum of currency, credit code and identification code to server 44 with the agreement of the user.

For purposes of this specification and the accompanying claims, the term “vendor” includes any entity offering for sale any good or service. For purposes of this specification and the accompanying claims, the phrase “offering for sale” includes all means of commerce, including but not limited to, Internet sales known as e-commerce, mail order sales, telephone sales, fax order sales and physical purchase at a point of sale.

A vendor will typically employ a vendor server 42 to communicate with server 44 and ascertain the availability of funds prior to completing a transaction with the user. Vendor server 42 can be a Web server to effect Internet e-commerce.

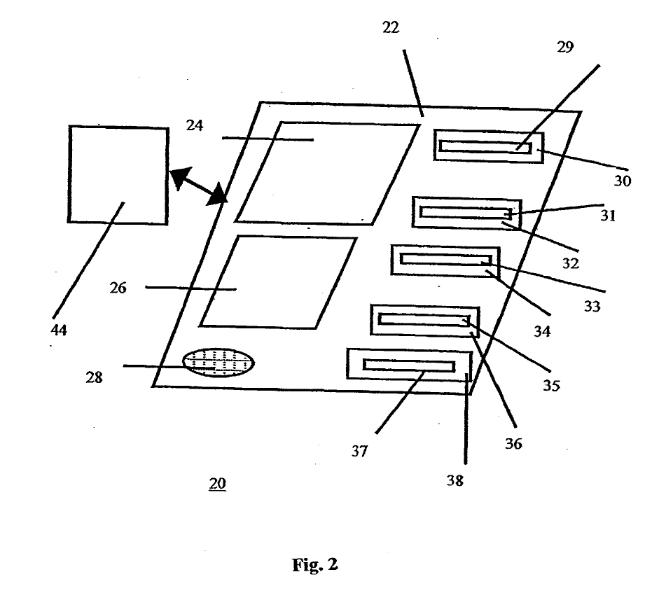

It should be appreciated that the identification code and the credit code are each preferably a string of alphanumeric characters and that use of these strings of alphanumeric characters does not necessarily require that they be written or printed on any tangible media. Accordingly, as shown in FIG. 2, the credit code may be issued, for example, as a string of alphanumeric characters displayed upon a visual display 24 of automatic teller or point of sell machine 20, or as a string of alphanumeric characters delivered audibly from a speaker 28 of automatic teller or point of sell machine 20, or as a string of alphanumeric characters printed upon a tangible media (e.g., a slip of paper or a plastic card) by automatic teller or point of sell machine 20. Because the identification code and the credit code are independent of tangible media, they may easily be communicated by a user to a vendor by, for example, telephone, fax, or Internet.

The identification code associated with the credit code may be generated in a number of ways including, but not limited to, the following four exemplary cases.

In the first case, a user may choose an identification code and communicate the chosen identification code to server 44 by means of an input device 26 of automatic teller or point of sell machine 20. Input device 26 may be a keypad, as pictured in FIG. 2, or a touch-screen or any other input device.

In the second case, a user may choose an identification code and communicate the chosen identification code to server 44 by means of an input device of a user client 40 which is at the discretion of the user. User client 40 is typically a personal computer and, as such, the most common input device will be a computer keyboard. However, other user clients, such as cellular telephones with computing capabilities might be employed, in which case the input device would be the keypad of the cellular telephone. Any user client 40 capable of communicating with server 44 might be employed without significantly affecting the overall functionality of the present invention. In this case establishing the virtual user account and account activation are conducted as two separate locations.

In the third case automatic teller or point of sell machine 20 assigns the identification code, communicates the assigned identification code to server 44, and provides the assigned identification code to the user.

In the fourth case, server 44 assigns the identification code and provides the assigned identification code to the user. This provision may is be either via automatic teller or point of sell machine 20 at the time the virtual user account is established or via user client 40 at a later time.

As is further shown in FIG. 2, automatic teller or point of sell machine 20 may be designed and configured in a number of ways in order to implement the present invention.

Typically, automatic teller or point of sell machine 20 will feature an armored faceplate 22 which conceals many mechanical and electronic components thereof from a user, and prevents theft of any contents of automatic teller or point of sell machine 20 such as money and/or data. Automatic teller or point of sell machine 20 will typically further include a monitor 24 for visual display of data such as, for example a credit code, an identification code or a current balance of a user account and/or virtual user account.

Automatic teller or point of sell machine 20 may further include a printer 30 for printing data on a tangible media, for example paper or plastic. The tangible media is deliverable to a user via a slot 29 in faceplate 22. Tangible media may be used to inform a user of, for example, a credit code, a identification code or a current balance of a user account and/or a virtual user account. Any or all of this data may be present either in a legible form, or as a bar code, or in both forms.

Automatic teller or point of sell machine 20 will typically include a data input device 26 pictured herein as a keyboard. Input device 26 may be used to perform a variety of functions including, but not limited to, selection of a credit code, selection of an identification code, selection of an opening balance for a new virtual user account, combination of two or more virtual user account balances, depositing remaining balances of virtual user accounts in other accounts, and/or cashing them as currency. In some cases input device 26 may be in the form of a touch-activated screen so that the function of input device 26 is physically indistinguishable from display 24.

Automatic teller or point of sell machine 20 may further include a mechanism 32 for accepting, identifying and counting currency of at least one type in order to allow accepting from the user an amount of currency. Currency is insertable to mechanism 32 via slot 31 in faceplate 22. The phrase “at least one type” here refers to at least one denomination in one currency, for example US one dollar bills. It will be appreciated that, in some cases, a user may wish to deposit currency of a first type (eg., US dollars) into automatic teller or point of sell machine 20 and open a virtual user account in currency of a second type (e.g., French Francs). Mechanisms for accepting, identifying and counting currency of at least one type are commercially available and those skilled in the art will be familiar with method for incorporation thereof into an automatic teller or point of sell machine.

Automatic teller or point of sell machine 20 may further include at least one audio speaker 28 for delivery of audio data, for example, a credit code, an identification code or a current balance of a user account and/or a virtual user account.

Automatic teller or point of sell machine 20 may further include at least one mechanism 36 for reading information encoded on a magnetic stripe, such as a magnetic stripe of the type commonly found on an automatic teller or point of sell machine card, in order to allow debiting an account of the user. A tangible media bearing a magnet stripe is insertable into mechanism 36 via slot 35 in faceplate 22.

Automatic teller or point of sell machine 20 may further include a bar code reader 34 for decoding information such as a credit code printed as a bar code. This feature is potentially useful for combining balances of two or more virtual user accounts. Tangible media imprinted with a bar code might be, for example, inserted in slot 33 of faceplate 22 to be read by reader 34.

Automatic teller or point of sell machine 20 may further include a dispenser 38 of pre-printed items. These preprinted items, in the form of plastic cards or cardboard cards, would be stored in dispenser 38 and dispensed via slot 37 in faceplate 22. Items stored in dispenser 38 would typically be preprinted with a credit code. In some cases a denomination, for example $100, might also be preprinted. This information might additionally appear as a bar code or encoded in a magnetic stripe in order to facilitate subsequent reading by bar code reader 34 or stripe reader 36. Features of bar code reader 34 or stripe reader 36 might be built into dispenser 38 so that automatic teller or point of sell machine 20 can acquire data pertaining to the credit code and the amount of currency to communicate to server 44.

Use of system 50 of the present invention constitutes a method of facilitating electronic monetary transactions. The method includes taking the steps of providing automatic teller or point of sell machine 20 and providing server 44. Automatic teller or point of sell machine 20 is capable of performing three functions relevant to the present invention. The first function includes debiting an account of a user and/or accepting from the user an amount of currency. The second function includes issuing or receiving from a server a credit code associated with the amount of currency and informing the user of the credit code. The third function includes updating server 44 by communicating thereto the amount of currency and if required, the credit code associated therewith to sever 44, thereby establishing a virtual user account. Server 44 is capable of communication with automatic teller or point of sell machine 20, and of performing three functions relevant to the present invention. The first function includes receiving from automatic teller or point of sell machine 20 the credit code and the amount of currency associated therewith. The second function includes receiving or issuing a personalized identification code and associating the identification code with the credit code, thereby activating the virtual user account The third function includes debiting the virtual user account by a specified sum of currency upon request when presented with the credit code, identification code and the specified sum.

Thus, the present invention provides a system and method for conducting electronic monetary transactions which reduce the risk of fraud and theft, and which flier protect consumer privacy, during purchases conducted electronically, telephonically, via facsimile, etc., which allows concurrent establishment and activation of a virtual user account, which may be used to conduct a wide variety of transactions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for facilitating electronic monetary transactions, the system comprising:
(a) an automatic teller machine being constructed and designed for:
(i) debiting an account of a user and/or accepting from the user an amount of currency;
ii) issuing or receiving from a server a credit code being associated with said amount of currency and informing the user of said credit code; and
(iii) updating said server with said amount of currency and, if required, with said credit code being associated therewith, thereby establishing a virtual user account at said server, and
(b) said server, being capable of communication with said automatic teller machine and being constructed and designed for:
(i) receiving data from said automatic teller machine of said amount of currency and, if required, said credit code being associated therewith;
(ii) receiving or issuing an identification code and associating said identification code with said credit code, thereby activating said virtual user account; and
(iii) debiting said virtual user account by a specified sum of currency upon request when presented with said credit code, identification code and said specified sum.

2. The system of claim 1, wherein said account of said user is selected from the group consisting of a bank account, a debit card account, a credit card account and a second virtual user account, whereas said automatic teller machine is fiber constructed and designed for communicating with a server of a bank or credit or debit provider.

3. The system of claim 1, wherein said specified sum of currency, credit code and identification code are presented to said server by said user via a user client at a discretion of said user.

4. The system of claim 1, wherein said specified sum of currency, credit code and identification code are presented to said server by a vendor with the agreement of said user.

5. The system of claim 1, wherein said identification code and said credit code are each independently a string of alphanumeric characters.

6. The system of claim 1, wherein said credit code is issued in a form selected from the group consisting of a string of alphanumeric characters displayed upon a visual display, a string of alphanumeric characters delivered audibly from a speaker and a string of alphanumeric characters printed upon a tangible media

7. The system of claim 1, wherein said identification code associated with said credit code is generated by a means selected from the group consisting of:
(i) a user choice of said identification code communicated to said server by means of an input device of said automatic teller machine;
(ii) a user choice of said identification code communicated to said server by means of an input device of a user client at a discretion of said user;
(iii) an assignment by said automatic teller machine of said identification code, once assigned said identification code being subsequently communicated to said server and provided to said user, and
(iv) an assignment by said server of said identification code, once assigned said identification code being subsequently provided to said user.

8. The system of claim 1 where said automatic teller machine includes at least one item selected from the group consisting of:
(i) a monitor for visual display of data;
(ii) a printer for printing data on a tangible media;
(iii) a data input device;
(iv) a mechanism for accepting, identifying and counting currency of at least one types;
(v) at least one audio speaker for delivery of audio data;
(vi) at least one mechanism for reading information encoded on a magnetic stripe;
(vii) a bar code reader; and
(viii) a dispenser of preprinted items.

9. A method of facilitating electronic monetary transactions, the method comprising the steps of:
(a) providing an automatic teller machine for:
(i) debiting an account of a user and/or accepting from the user an amount of currency,
(ii) issuing or receiving from a server a credit code being associated with said amount of currency and informing the user of said credit code; and
(iii) updating said server with said credit code and said amount of currency being associated therewith, thereby establishing a virtual user account; and
(b) providing said server, capable of communication with said automatic teller machine, said server being for:
(i) receiving from said automatic teller machine said credit code and said amount of currency being associated therewith;
(ii) receiving or issuing a personalized identification code and associating said identification code with said credit code, thereby activating said virtual user account; and
(iii) debiting said virtual user account by a specified sum of currency upon request when presented with said credit code, identification code and said specified sum.

10. The method of claim 9, wherein said debiting of an account debits an account selected from the group consisting of a bank account, a debit card account, a credit card account and a second virtual user account.

11. The method of claim 9, wherein presentation of said specified sum, credit code and identification code to said server is performed by said user via a user client.

12. The method of claim 9, wherein presentation of said specified sum, credit code and identification code to said server is performed by a vendor with the agreement of said user.

13. The method of claim 9, wherein said identification code and said credit code are each individually alphanumeric character strings.

14. The method of claim 9, wherein said credit code is issued by performing an action selected from the group consisting of displaying an alphanumeric character string upon a visual display, delivering an alphanumeric character string audibly from a speaker, printing an alphanumeric character string upon a tangible media.

15. The method of claim 9, wherein generation of said identification code associated with said credit code in said user account is accomplished by a means selected from the group consisting of:
(i) said user choosing said identification code and communicating said chosen identification code to said server by means of an input device of said automatic teller machine;
(ii) said user choosing said identification code and communicating said chosen identification code to said server by means of an input device of a user client;
(iii) said automatic teller machine assigning said identification code, said assigned identification code being subsequently communicated to both said server and said user, and
(iv) said server assigning said identification code, said assigned identification code being subsequently communicated to said user.

16. The method of claim 9, where said automatic teller machine is capable of at least one action selected from the group consisting of:
(i) displaying visual data on a monitor;
(ii) printing data on a tangible media;
(iii) receiving a data input from a data input device;
(iv) accepting, identifying and counting currency of at least one type;
(v) delivering audio data from at least one audio speaker;
(vi) reading information encoded on a magnetic stripe;
(vii) reading a bar code; and
(viii) dispensing pre-printed items.

17. A system for facilitating electronic monetary transactions, the system comprising:
(a) an automatic point of sell machine being constructed and designed for:
(i) debiting an account of a user and/or accepting from the user an amount of currency;
(ii) issuing or receiving from a server a credit code being associated with said amount of currency and informing the user of said credit code; and
(iii) updating said server with said amount of currency and, if required, with said credit code being associated therewith, thereby establishing a virtual user account at said server; and
(b) said server, being capable of communication with said automatic point of sell machine and being constructed and designed for:
(i) receiving data from said automatic point of sell machine of said amount of currency and, if required, said credit code being associated therewith;
(ii) receiving or issuing an identification code and associating said identification code with said credit code, thereby activating said virtual user account; and
(iii) debiting said virtual user account by a specified sum of currency upon request when presented with said credit code, identification code and said specified sum.

18. The system of claim 17, wherein said account of said user is selected from the group consisting of a bank account, a debit card account, a credit card account and a second virtual user account, whereas said automatic point of sell machine is further constructed and designed for communicating with a server of a bank or credit or debit provider.

19. The system of claim 17, wherein said specified sum of currency, credit code and identification code are presented to said server by said user via a user client at a discretion of said user.

20. The system of claim 17, wherein said specified sum of currency, credit code and identification code are presented to said server by a vendor with the agreement of said user.

21. The system of claim 17, wherein said identification code and said credit code are each independently a string of alphanumeric characters.

22. The system of claim 17, wherein said credit code is issued in a form selected from the group consisting of a string of alphanumeric characters displayed upon a visual display, a string of alphanumeric characters delivered audibly from a speaker and a string of alphanumeric characters printed upon a tangible media.

23. The system of claim 17, wherein said identification code associated with said credit code is generated by a means selected from the group consisting of:
(i) a user choice of said identification code communicated to said server by means of an input device of said automatic point of sell machine;
(ii) a user choice of said identification code communicated to said server by means of an input device of a user client at a discretion of said user;
(iii) an assignment by said automatic point of sell machine of said identification code, once assigned said identification code being subsequently communicated to said server and provided to said user; and
(iv) an assignment by said server of said identification code, once assigned said identification code being subsequently provided to said user.

24. The system of claim 17, where said automatic point of sell machine includes at least one item selected from the group consisting of:
(i) a monitor for visual display of data;
(ii) a printer for printing data on a tangible media;
(iii) a data input device;
(iv) a mechanism for accepting, identifying and counting currency of at least one types;
(v) at least one audio speaker for delivery of audio data;
(vi) at least one mechanism for reading information encoded on a magnetic stripe;
(vii) a bar code reader; and
(viii) a dispenser of pre-printed items.

25. A method of facilitating electronic monetary transactions, the method comprising the steps of:
(a) providing an automatic point of sell machine for:
(i) debiting an account of a user and/or accepting from the user an amount of currency;
(ii) issuing or receiving from a server a credit code being associated with said amount of currency and informing the user of said credit code; and
(iii) updating said server with said credit code and said amount of currency being associated therewith, thereby establishing a virtual user account; and
(b) providing said server, capable of communication with said automatic point of sell machine, said server being for:
(i) receiving from said automatic point of sell machine said credit code and said amount of currency being associated therewith;
(ii) receiving or issuing a personalized identification code and associating said identification code with said credit code, thereby activating said virtual user account; and
(iii) debiting said virtual user account by a specified sum of currency upon request when presented with said credit code, identification code and said specified sum.

26. The method of claim 25, wherein said debiting of an account debits an account selected from the group consisting of a bank account, a debit card account, a credit card account and a second virtual user account.

27. The method of claim 25, wherein presentation of said specified sum, credit code and identification code to said server is performed by said user via a user client.

28. The method of claim 25, wherein presentation of said specified sum, credit code and identification code to said server is performed by a vendor with the agreement of said user.

29. The method of claim 25, wherein said identification code and said credit code are each individually alphanumeric character strings.

30. The method of claim 25, wherein said credit code is issued by performing an action selected from the group consisting of displaying an alphanumeric character string upon a visual display, delivering an alphanumeric character string audibly from a speaker, printing an alphanumeric character string upon a tangible media.

31. The method of claim 25, wherein generation of said identification code associated with said credit code in said user account is accomplished by a means selected from the group consisting of:
(i) said user choosing said identification code and communicating said chosen identification code to said server by means of an input device of said automatic point of sell machine;
(ii) said user choosing said identification code and communicating said chosen identification code to said server by means of an input device of a user client;
(iii) said automatic point of sell machine assigning said identification code, said assigned identification code being subsequently communicated to both said server and said user; and
(iv) said server assigning said identification code, said assigned identification code being subsequently communicated to said user.

32. The method of claim 25, where said automatic point of sell machine is capable of at least one action selected from the group consisting of:
(i) displaying visual data on a monitor;
(ii) printing data on a tangible media;
(iii) receiving a data input from a data input device;
(iv) accepting, identifying and counting currency of at least one type;
(v) delivering audio data from at least one audio speaker;
(vi) reading information encoded on a magnetic stripe;
(vii) reading a bar code; and
(viii) dispensing pre-printed items.
